(19) United States
(12) Patent Application Publication
(10) Pub. No.: US 2026/0001723 A1
(43) Pub. Date: Jan. 1, 2026

(54) Rotating Device For Beverages

(71) Applicant: LITING HU, Shenzhen (CN)

(72) Inventor: LITING HU, Shenzhen (CN)

(21) Appl. No.: 18/755,658

(22) Filed: Jun. 26, 2024

(51) Int. Cl. B65G 19/02; B65G 19/22; B65G 19/28

(52) U.S. Cl. CPC B65G 19/02; B65G 19/225; B65G 19/282; B65G 2201/0244

(57) ABSTRACT

A rotating device for beverages including a bottom case, a plurality of rollers, and a plurality of trays. The bottom case is provided with a limit track in a closed loop, the plurality of rollers are disposed on the bottom case and distributed alongside the limit track, and the plurality of trays are circular pieces having the same diameter, the circular pieces being arranged in an eclipsed conformation and trays movably disposed on the bottom case. The plurality of trays are in contact with corresponding rollers, each tray has a post on bottom, and the post are inserted in the limit track and move along the limit track.

### TECHNICAL FIELD

The present application relates to the technical field of rotating devices, and in particular to a rotating device for beverages.

### BACKGROUND

A refrigerator is a common household product that keeps food or other items at a constant low temperature. The inside of the refrigerator is equipped with a cabinet or a box containing a compressor, an ice maker for icing, and a storage room with a refrigeration device.

The refrigerator is an appliance that may refrigerate beverages, and the refrigerator in every home is filled with a variety of bottled beverages, which are usually stacked from inside to outside. When users need to take out the inside one, they need to remove the outside one. And when the users take out their desired beverage, it is necessary to put the removed beverages back into the refrigerator, this makes it inconvenient to get an inside beverage. Therefore, it is necessary to study a solution to solve the above problems.

### SUMMARY

In view of deficiencies in existing technologies, the present disclosure aims to provide a rotating device for beverages, which can effectively solve problems of inconveniently taking out beverages inside, that is, in the rear of the refrigerator.

To achieve the above objectives, the present disclosure adopts the following technical solutions. In some embodiments of the present disclosure, a rotating device for beverages is provided, including a bottom case, a plurality of rollers, and a plurality of trays. Herein the bottom case is provided with a limit track in a closed loop, the plurality of rollers are disposed on the bottom case and distributed alongside of the limit track, and the plurality of trays are circular pieces having the same diameter, the circular pieces being arranged in an eclipsed conformation and movably disposed on the bottom case. The plurality of trays are in contact with corresponding rollers, each tray has a limited post on the bottom, and the limited post is inserted in the limit track and moves along the limit track.

Preferably, the bottom case comprises an outer cover plate and an inner cover plate, the outer cover plate is provided with an outer guardrail, the inner cover plate is provided with an inner guardrail, a tray containing a slot is formed between the outer guardrail and the inner guardrail, and the plurality of trays are located in the tray containing slot.

Preferably, the outer guardrail is provided with an output port connected to the tray containing the slot.

Preferably, the plurality of rollers are arranged in two rows, two rows of the rollers are arranged in a circular pattern, and the two rows of the rollers each is located near to the inner side of the limit track.

Preferably, the bottom case is concavely provided with a concave cavity and multiple sets of support plates extend from the concave cavity, each set of the support plates consists of two spaced apart support plates, and the support plates are provided with slots at the top thereon, the rollers are located between the two spaced apart support plates, and ends of the rollers are mounted on the slots of the two spaced apart support plates.

Preferably, the limited post is fixedly provided with a limit wheel, and the limit wheel is in sliding contact with an inner wall of the limit track.

Preferably, the limit track is in the shape of a runway.

The rotating device for beverages of the present disclosure has obvious advantages and beneficial effects compared with the existing technologies, specifically, as can be seen from the above technical solutions, by setting the plurality of trays, and with cooperation of limit track and the plurality of rollers, the plurality of trays can be rotated along the limit track in a horizontal position, a variety of bottled beverages can be placed on the trays and move along with the rotary movement of the trays, which is convenient for the users to rotate desired bottled beverages out of the trays, it is also convenient to take them out, and thus it is worth to popularize use of such device.

### BRIEF DESCRIPTION OF THE DRAWINGS

FIG. 1 shows an assembled stereogram of a rotating device for beverages in accordance with some preferred embodiments of the present disclosure.

FIG. 2 shows an assembled stereogram from another angle of the rotating device for beverages in accordance with some preferred embodiments of the present disclosure.

FIG. 3 shows an exploded view of the rotating device for beverages in accordance with some preferred embodiments of the present disclosure.

FIG. 4 shows an exploded view from another angle of the rotating device for beverages in accordance with some preferred embodiments of the present disclosure.

In the drawings, reference signs are as follows. 10. Bottom case, 11. Outer cover plate, 111. Outer guardrail, 112. Output port, 12. Inner cover plate, 121. Inner guardrail, 101. Limit track, 102. Tray containing slot, 103. Concave cavity, 104. Support plate, 105. Slot, 20. Roller, 30. Trays, 31. Limited post.

### DETAILED DESCRIPTION OF THE EMBODIMENTS

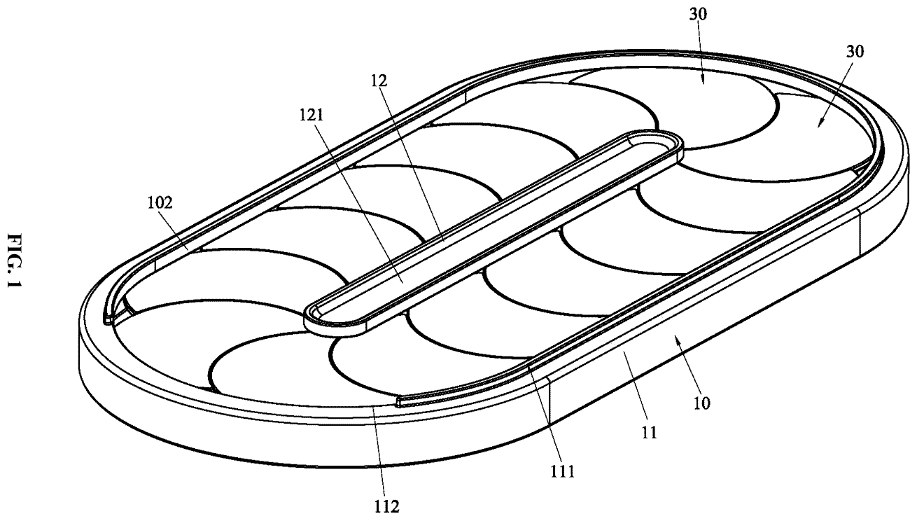

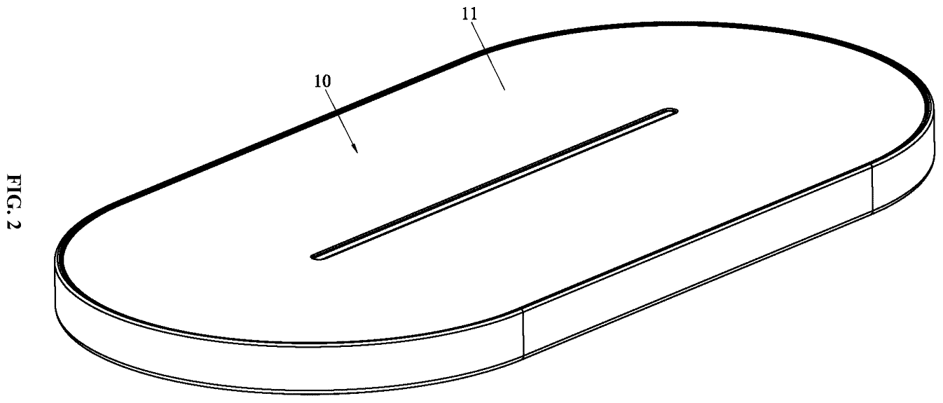

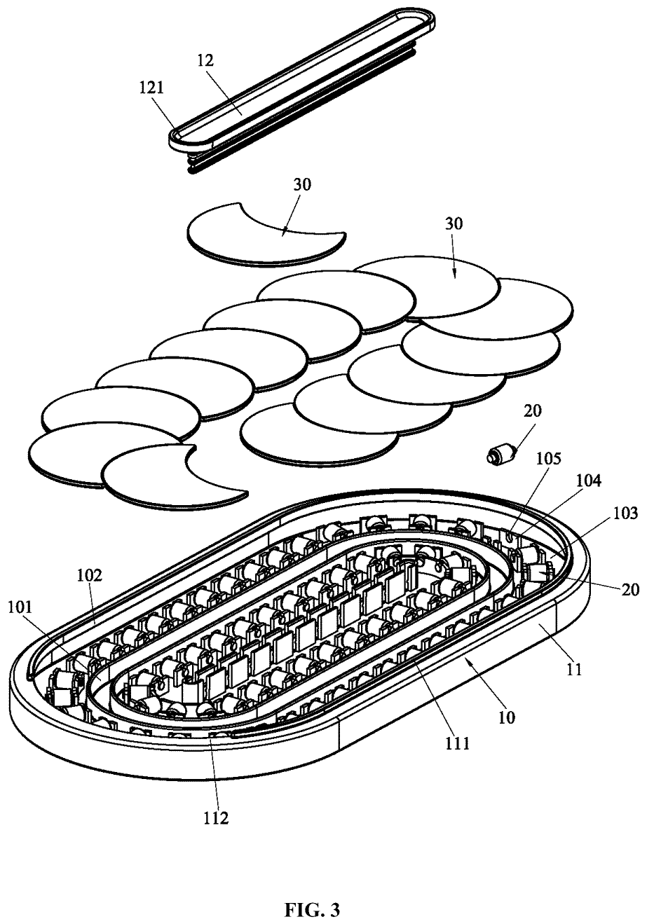

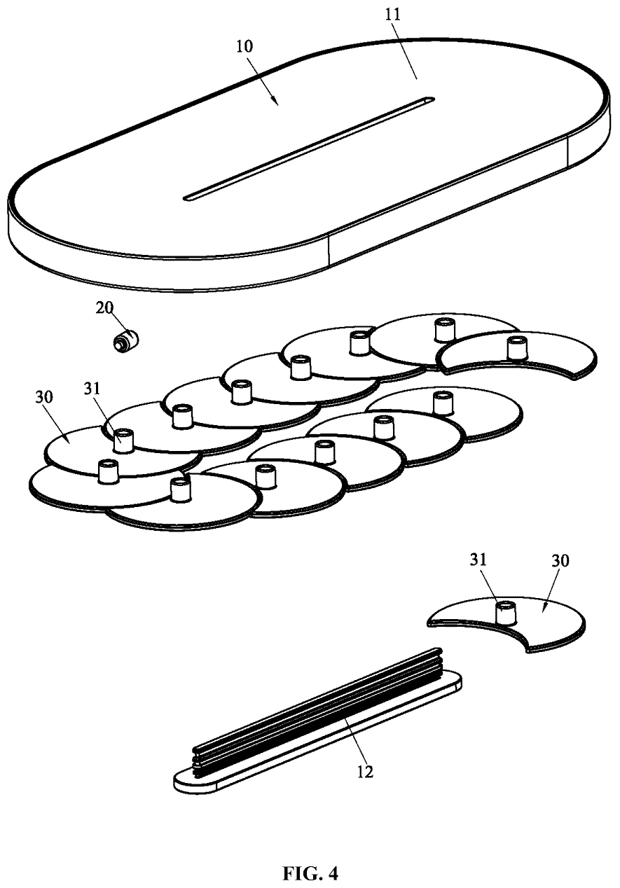

As shown in FIG. 1 to FIG. 4, which shows a specific structure of a rotating device for beverages in accordance with some embodiments of the present disclosure, including a bottom case 10, a plurality of rollers 20, and a plurality of trays 30.

The bottom case 10 is provided with a limit track 101, and the limit track 101 is in a closed ring. In some embodiments of the present disclosure, the limit track 101 is in a shape of runway. Specifically, the bottom case 10 consists of an outer cover plate 11 and an inner cover plate 12, the outer cover plate 11 is provided with an outer guardrail 111, the inner cover plate 12 is provided with an inner guardrail 121, a tray containing slot 102 is formed between the outer guardrail 111 and the inner guardrail 121. The outer guardrail 111 is provided with an output port 112, and the output port 112 is connected to the tray containing slot 102. Moreover, the bottom case 10 is concavely provided with a concave cavity 103 and multiple sets of support plates 104 extend from the concave cavity 103, each set of the support plates 104 consists of two spaced apart support plates 104, the support plates 104 are provided with slots 105 at top thereon.

The plurality of rollers 20 are disposed on the bottom case 10 and distributed on the sides of the limit track 101. In some embodiments of the present disclosure, the plurality of rollers 20 are arranged in two rows, two rows of rollers 20 are arranged in a circular pattern, and the two rows of rollers 20 each are located in the inner side of the limit track 101. Furthermore, the rollers 20 are located between two adjacent support plates 104, and the ends of the rollers 20 are mounted on the slots 105 of the two adjacent support plates 104 to make the installation of the rollers 20 simple and reliable and the rollers 20 rotate smoothly.

The plurality of trays 30 are circular pieces having the same diameter, the circular pieces are arranged in an eclipsed conformation and movably disposed on the bottom case 10, and the plurality of trays 30 are in contact with corresponding rollers 20. Each of the trays 30 has a limited post 31 at the bottom thereon, and the limited post 31 is inserted in the limit track 101 and moves along the limit track 101. In some embodiments of the present disclosure, the plurality of trays 30 is located in the tray containing slot 102 to limit the plurality of trays 30 for better rotational activity along a trajectory to avoid derailment. The trays 30 have a curved sheet structure. Furthermore, a limit wheel (not shown in the figures) may also be fixed to the limited post 31, which is in sliding contact with the inner wall of the limit track 101, so as to make the rotational activity of the trays 30 along the limit track 101 smoother and silkier.

An operating method of the rotating device for beverages of the present disclosure is described in detail as follows.

When in use, the rotating device for beverages of the present disclosure is placed in a refrigerator, and various bottled beverages are placed on each of the trays 30. When a force is subjected to one of the bottled beverages, the plurality of trays 30 slides along the limit track 101 under the cooperation of the plurality of rollers 20, thereby causing the plurality of rollers 20 to do rotational movement on a horizontal plane, and the plurality of bottled beverages move with corresponding trays 30, in this way, when one desired bottled beverage is rotated and moved to a side near the refrigerator door, a user can pick it up, and thus it is easy to take it out.

Designs of the present disclosure focuses on that, by setting the plurality of trays, and with cooperation of limit track and the plurality of rollers, the plurality of trays can be rotated along the limit track in the horizontal plane, the variety of bottled beverages can be placed on the trays and move along with the rotary movement of the trays, which is convenient for the user to rotate desired bottled beverages out of the trays, it is also convenient to take them out, and thus it is worth to popularize use of such device.

Technical principles of the present disclosure are described above in connection with specific embodiments. These descriptions are only intended to explain the principles of the present disclosure, and are not to be construed in any way as a limitation of the scope of protection of the present disclosure. Based on explanations herein, a person skilled in the art can associate other specific embodiments of the present disclosure without creative labor, and these other specific embodiments shall fall within the scope of protection of the present disclosure.

What is claimed is:

1. A rotating device for beverages, comprising a bottom case, a plurality of rollers, and a plurality of trays;
wherein the bottom case is provided with a limit track in a closed loop, the plurality of rollers are disposed on the bottom case and distributed alongside the limit track, and the plurality of trays are circular pieces having the same diameter, the circular pieces being arranged in an eclipsed conformation and movably disposed on the bottom case; and
wherein the plurality of trays are in contact with corresponding rollers, each tray has a post on bottom, and the post are inserted in the limit track and move along the limit track.

2. The rotating device for beverages according to claim 1, wherein the bottom case comprises an outer cover plate and an inner cover plate, the outer cover plate is provided with an outer guardrail, the inner cover plate is provided with an inner guardrail, a tray containing slot is formed between the outer guardrail and the inner guardrail, and the plurality of trays are located in the tray containing slot.

3. The rotating device for beverages according to claim 2, wherein the outer guardrail is provided with an output port connected to the tray containing slot.

4. The rotating device for beverages according to claim 1, wherein the plurality of rollers are arranged in two rows, two rows of the rollers are arranged in a circular pattern, and the two rows of the rollers each is located near to an inner side of the limit track.

5. The rotating device for beverages according to claim 1, wherein the bottom case is concavely provided with a concave cavity and a multiple sets of support plates extend from the concave cavity, each set of the support plates consists of two spaced apart support plates, the support plates are provided with slots at top thereon, the rollers are located between the two spaced apart support plates, and ends of the rollers are mounted on the slots of the two spaced apart support plates.

6. The rotating device for beverages according to claim 1, wherein the post is fixedly provided with a limit wheel and the limit wheel is in sliding contact with an inner wall of the limit track.

7. The rotating device for beverages according to claim 1, wherein the limit track is in a shape of runway.
